(19) United States
(12) Patent Application Publication
(10) Pub. No.: US 2026/0035041 A1
(43) Pub. Date: Feb. 5, 2026

(54) VEHICLE FRONT STRUCTURE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/058,251

(22) Filed: Feb. 20, 2025

(30) Foreign Application Priority Data
Aug. 5, 2024 (JP) 2024-129186

(51) Int. Cl. B62D 25/08; B60K 11/02

(52) U.S. Cl. CPC B62D 25/084; B60K 11/02

(57) ABSTRACT

A vehicle front structure includes a suspension tower bar that connects upper portions of a pair of suspension towers in a front portion of a vehicle to each other, a cross member that is disposed in front of and below the suspension tower bar and connects right and left vehicle body structure members to each other, a pair of brackets that is bridged between the suspension tower bar and the cross member and is disposed at intervals in right and left, and an equipment module. The equipment module is configured to include a plurality of pieces of equipment of a refrigeration cycle used for adjusting the temperature of the vehicle cabin air and the traction battery. The equipment module is disposed between a pair of brackets and fixed to each of the brackets.

### CROSS-REFERENCE TO RELATED APPLICATION

This application claims priority to Japanese Patent Application No. 2024-129186 filed on Aug. 5, 2024. The disclosure of the above-identified application, including the specification, drawings, and claims, is incorporated by reference herein in its entirety.

### BACKGROUND

### 1. Technical Field

The present specification discloses a vehicle front structure including a suspension tower bar that connects a pair of suspension towers.

### 2. Description of Related Art

In the related art, a vehicle having a suspension tower bar configured to connect the upper portions of a pair of right and left suspension towers in a front portion of the vehicle is known. The suspension tower bar suppresses deformation of the body due to tensile force or twisting force received from the suspension tower via the tire and the suspension during traveling of the vehicle, and improves the body rigidity.

Japanese Unexamined Patent Application Publication No. 2007-230489 (JP 2007-230489 A) discloses a vehicle having a suspension tower bar.

### SUMMARY

When the vehicle travels or when the vehicle receives a side collision, a structure is desired in which the movement of the suspension tower bar in the vehicle width direction is restricted to suppress the body deformation.

The present specification discloses a vehicle front structure capable of suppressing a movement of a suspension tower bar in a vehicle width direction when the vehicle travels or when the vehicle receives a side collision.

A vehicle front structure disclosed in the present specification includes a suspension tower bar configured to connect upper portions of a pair of right and left suspension towers provided in a front portion of a vehicle to each other, a cross member that is disposed forward in a vehicle front-rear direction and downward in a vehicle up-down direction of the suspension tower bar and configured to connect right and left vehicle body structures to each other, a pair of brackets that is bridged between the suspension tower bar and the cross member, the brackets being disposed at an interval in a right-left direction, and an equipment module including a plurality of pieces of equipment of a refrigeration cycle that is used for adjusting a temperature of vehicle cabin air and a traction battery. The equipment module is disposed between the brackets and is fixed to each of the brackets.

With the above configuration, when the vehicle travels, the force toward one side in the vehicle width direction (vehicle right-left direction) generated in the suspension tower bar due to the force received from the suspension tower can be transmitted, via the brackets and the equipment module, to the vehicle body structure to which the cross member is connected. Therefore, the movement of the suspension tower bar in the vehicle width direction can be suppressed, and the twisting of the body during traveling of the vehicle can be suppressed.

In addition, with the above configuration, when the vehicle receives the side collision, the load that is applied to one side in the vehicle width direction (vehicle right-left direction) of the suspension tower bar due to the collision load can be transmitted, via the brackets and the equipment module, to the vehicle body structure to which the cross member is connected. Therefore, the movement of the suspension tower bar in the vehicle width direction can be suppressed, and the amount of intrusion of the collision object into the vehicle body can be reduced.

In the vehicle front structure according to the present disclosure, each of the brackets may include an upper portion fixed to the suspension tower bar and extending forward in the vehicle front-rear direction, a pillar portion extending downward in the vehicle up-down direction from a distal end of the upper portion on a front side of the vehicle, and a lower portion fixed to the cross member and extending forward in the vehicle front-rear direction from a lower end of the pillar portion, and the equipment module may be fixed to the upper portion and the lower portion of the brackets.

With the above configuration, the equipment module is fixed to the upper portion of the bracket to which the suspension tower bar is fixed and the lower portion of the bracket to which the cross member is fixed. Therefore, the load generated in the suspension tower bar toward one side in the vehicle width direction (the right-left direction of the vehicle) can be efficiently transmitted from the suspension tower bar to the vehicle body structure via the equipment module and the cross member.

In the vehicle front structure according to the present disclosure, the right and left suspension towers and the right and left vehicle body structures to which the cross member is connected may be a part of a cast component that is integrally molded.

According to the technique disclosed in the present specification, it is possible to suppress the movement of the suspension tower bar in the vehicle width direction when the vehicle travels or when the vehicle receives the side collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a vehicle front structure according to an embodiment;

FIG. 2 is a side view showing a bracket and members around the bracket;

FIG. 3 is a front view schematically showing a vehicle front structure according to the embodiment; and

FIG. 4 is a schematic diagram showing an example of a thermal management system.

### DETAILED DESCRIPTION OF EMBODIMENTS

Hereinafter, embodiments will be described with reference to the drawings. The same reference numerals are given to the same elements in all the drawings, and the redundant description will be omitted. In the following description, unless otherwise specified, a term representing a direction and an orientation such as front, rear, right, left, up, and down represents a direction and an orientation with respect to a vehicle. In each drawing, an arrow FR represents a front direction, an arrow UP represents an upward direction, and an arrow LH represents a left direction.

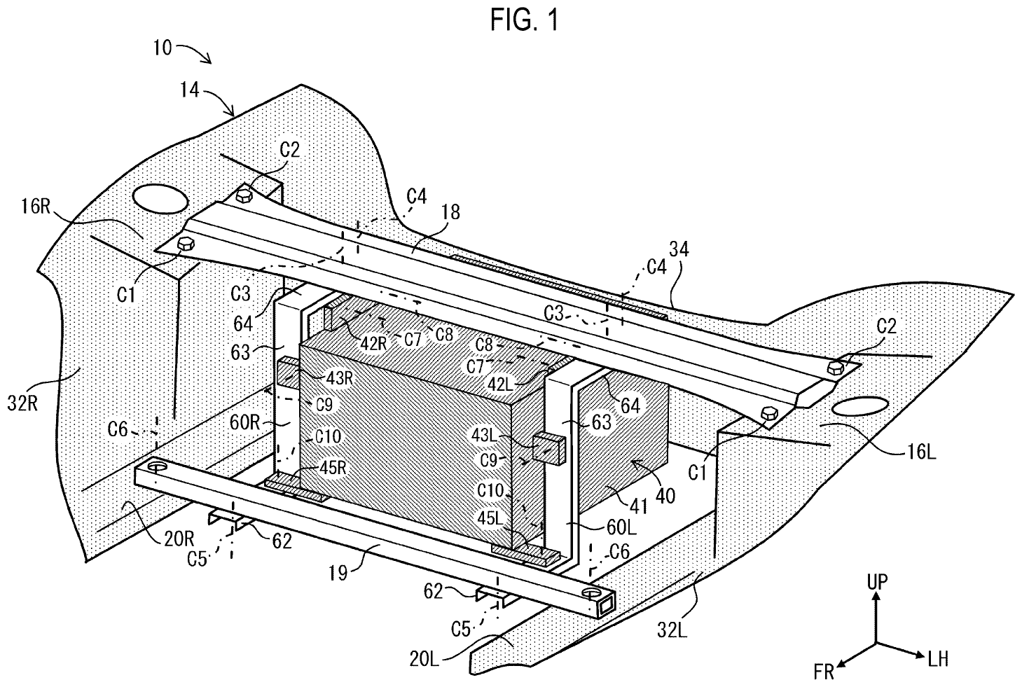

FIG. 1 is a perspective view showing a vehicle 10 according to an embodiment, and shows a part of a power unit compartment provided in a front portion of the vehicle. The vehicle 10 is a battery electric vehicle (BEV) including a battery that supplies electric power to a motor as a power source. The vehicle 10 may be, for example, a hybrid battery electric vehicle (HEV), a plug-in hybrid battery electric vehicle (PHEV), or the like, and the type of the vehicle 10 is not limited.

As shown in FIG. 1, the vehicle 10 includes a cast component 14, a suspension tower bar 18, a pair of brackets 60L, 60R, an equipment module 40, and a cross member 19. In addition, a part of the cast component 14 is shown in FIG. 1.

The cast component 14 is a cast and molded product made of a light metal such as aluminum. The cast component 14 is a large cast molded product called a giga cast or a mega cast, and has a shape that is symmetrical right and left or has a substantially symmetrical right and left shape. The cast component 14 includes a pair of right and left suspension towers 16R, 16L, a pair of right and left side panels 32R, 32L, a pair of right and left bottom structures 20R, 20L (also referred to as a vehicle body structure), and a connection panel 34.

The side panels 32L, 32R are panel portions extending from the respective suspension towers 16L, 16R in the front-rear direction. The bottom structures 20L, 20R are provided below the side panels 32L, 32R. The connection panel 34 connects a pair of right and left side panels 32R, 32L. A dash panel (not shown) that separates the vehicle cabin and the power unit compartment is joined to the connection panel 34.

A suspension tower bar 18 is fixed to an upper surface of each of the suspension towers 16L, 16R on an inner side in a vehicle width direction. The suspension tower bar 18 connects the upper portions of the pair of suspension towers 16L, 16R to each other.

The suspension tower bar 18 is configured to include, for example, two steel plates (an upper steel plate and a lower steel plate) that are press-processed. The suspension tower bar 18 is configured by coupling a flange portion of the upper steel plate processed into a hat-shaped cross section and a flange portion of the lower steel plate processed into a reverse hat-shaped cross section. The left end and the right end of the suspension tower bar 18 are fastened to the upper surfaces of the suspension towers 16L, 16R by two bolts, respectively. As a result, fastening points C1, C2 are provided at the left end and the right end of the suspension tower bar 18, respectively.

A pair of brackets 60L, 60R is fixed to a lower surface of the suspension tower bar 18. The brackets 60L, 60R are disposed at intervals in the right-left direction and are bridged between the suspension tower bar 18 and the cross member 19.

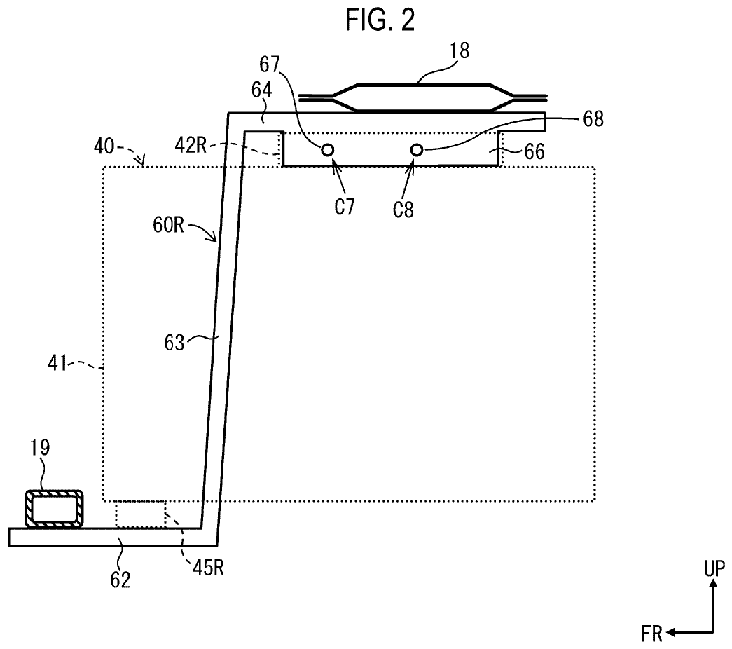

FIG. 2 is a side view showing a bracket 60R and members around the bracket 60R, and shows a side surface of the bracket 60R on the inside in the vehicle width direction. Although the bracket 60R and the mounting structure thereof will be described below, the bracket 60L also has a shape symmetrical right and left to the bracket 60R and has the same mounting structure as the bracket 60R.

The bracket 60R is a folded plate member including an upper portion 64, a pillar portion 63, and a lower portion 62. The upper portion 64 is fixed to the suspension tower bar 18 and extends in the front-rear direction. The pillar portion 63 extends downward from a distal end of the upper portion 64 on a vehicle front side. The lower portion 62 extends forward from the lower end of the pillar portion 63 and is fixed to the cross member 19.

As shown in FIG. 1 (see the distal end of the lower portion 62 of the bracket 60R), the bracket 60R has a shape in which both ends in the transverse direction are bent. Both ends of the lower portion 62 of the bracket 60R are bent downward. Both ends of the pillar portion 63 are bent backward. Both ends of the upper portion 64 are bent downward.

An upper surface of the upper portion 64 of the bracket 60R is fastened to the lower surface of the suspension tower bar 18 with two bolts. As a result, two fastening points C3, C4 are provided on the upper portion 64 of the bracket 60R in the front-rear direction.

As shown in FIG. 2, the upper portion 64 of the bracket 60R has a support portion 66 provided by extending a part of the end portion on the inner side of the vehicle width direction downward. The support portion 66 is positioned outside the vehicle width direction of the upper arm 42R of the equipment module 40. The support portion 66 has bolt penetration holes 67, 68 arranged in the front-rear direction, and two weld nuts (not shown) are provided at positions corresponding to the bolt through-holes 67, 68 on the surface of the support portion 66 on the outside of the vehicle width direction. The two bolts are screwed into two weld nuts of the support portion 66 through the bolt through-holes 67, 68 by penetrating the upper arm 42R of the equipment module 40. As a result, two fastening points C7, C8 are provided. With this configuration, the upper portion 64 of the bracket 60R holds the right upper portion of the equipment module 40.

A lower portion 62 of the bracket 60R is disposed below the cross member 19. The upper surface of the lower portion 62 of the bracket 60R and the lower surface of the cross member 19 are fastened with a bolt, and as shown in FIG. 1, a fastening point C5 is provided.

The cross member 19 is disposed in front of and below the suspension tower bar 18 and connects right and left bottom structures 20R, 20L (vehicle body structures). The cross member 19 has a hollow substantially rectangular cross section and extends in a vehicle width direction. The cross member 19 is, for example, a metal extruded material. The lower surfaces of the left end and the right end of the cross member 19 are fastened to the upper surfaces of the bottom structures 20L, 20R by bolts, respectively. As a result, the fastening points C6 are provided at the left end and the right end of the cross member 19.

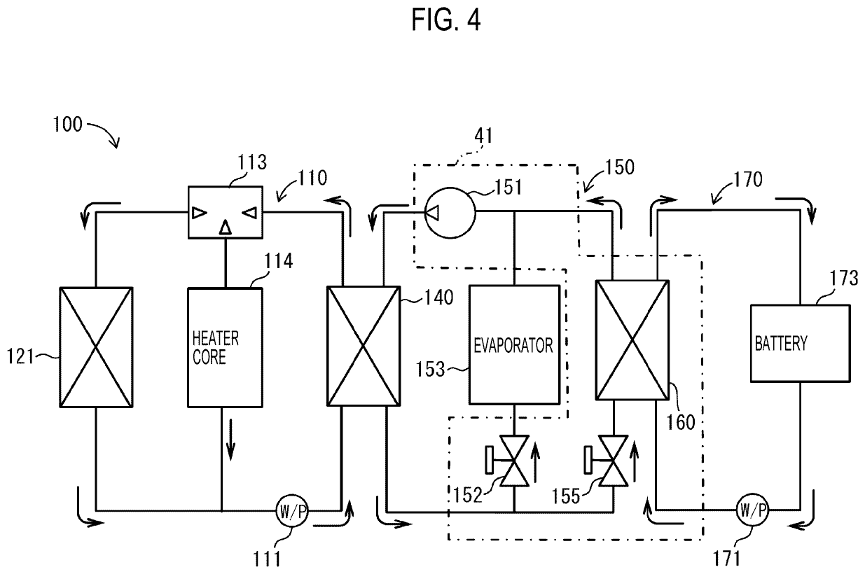

The equipment module 40 is disposed between a pair of brackets 60L, 60R and fixed to each of the pair of brackets 60L, 60R. The equipment module 40 includes a module body 41. The module body 41 is configured to include a plurality of pieces of equipment of the refrigeration cycle 150 used for adjusting the temperature of the vehicle cabin air and the traction battery 173 (see FIG. 4).

FIG. 4 is a schematic diagram showing an example of a thermal management system 100 mounted on the vehicle 10. The thermal management system 100 performs air conditioning of the vehicle cabin and cooling of the battery 173 (battery that supplies electric power to the traveling motor of the vehicle 10). The module body 41 of the equipment module 40 is configured to include the equipment inside the one-dot chain line in FIG. 4. That is, the module body 41 includes the compressor 151, the expansion valves 152, 155, and the chiller 160. The module body 41 may further include other equipment (a water pump, a heat exchanger, a valve, and the like) of the thermal management system 100.

The thermal management system 100 includes a refrigeration cycle 150, a high temperature circuit 110, and a battery circuit 170. In the refrigeration cycle 150, the refrigerant circulates. In the high temperature circuit 110, a heat medium (warm water) circulates. In the battery circuit 170, a heat medium (coolant) circulates.

The refrigeration cycle 150 includes a compressor 151, a condenser 140, an expansion valve 152, an evaporator 153, an expansion valve 155, and a chiller 160. The refrigerant that circulates the refrigeration cycle 150 flows through one of the first path and the second path, or both of the first path and the second path. The first path is a path of the compressor 151—the condenser 140—the expansion valve 152—the evaporator 153—the compressor 151. The second path is a path of the compressor 151—the condenser 140—the expansion valve 155—the chiller 160—the compressor 151.

The condenser 140 heats the heat medium (warm water) of the high temperature circuit 110 by the refrigerant of the refrigeration cycle 150. The evaporator 153 cools the air conditioning air blown into the vehicle cabin (vehicle cabin air) by the refrigerant of the refrigeration cycle 150. The chiller 160 cools the heat medium (coolant) of the battery circuit 170 by the refrigerant of the refrigeration cycle 150.

The high temperature circuit 110 includes a water pump (W/P) 111, a condenser 140, a three-way valve 113, a heater core 114, and a radiator 121. The warm water that circulates in the high temperature circuit 110 flows through one or both of the first path and the second path. The first path is a path of the water pump 111—the condenser 140—the three-way valve 113—the heater core 114—the water pump 111. The second path is the water pump 111—the condenser 140—the three-way valve 113—the radiator 121—the water pump 111.

The heater core 114 heats the air conditioning air blown into the vehicle cabin (vehicle cabin air) by the warm water of the high temperature circuit 110.

The battery circuit 170 includes a water pump (W/P) 171, a chiller 160, and a battery 173. The coolant that circulates the battery circuit 170 circulates the water pump 171, the chiller 160, and the battery 173. The battery 173 is cooled by the coolant of the battery circuit 170.

The thermal management system 100 is not limited to the embodiment shown in FIG. 4, and other embodiments may be adopted. For example, in FIG. 2 of Japanese Unexamined Patent Application Publication No. 2024-77237 (JP 2024-77237 A), in addition to the battery, a thermal management system (thermal management circuit) that performs temperature control of a step-up/step-down converter, a power control unit (PCU), a smart power unit (SPU, a unit for controlling charging and discharging of a battery), and an oil cooler (O/C) is disclosed. The module body 41 (see FIG. 1) of the equipment module 40 may be configured to include, for example, a plurality of pieces of equipment of the thermal management system disclosed in the publication.

As shown in FIG. 1, the equipment module 40 includes a pair of right and left upper arms 42R, 42L, a pair of right and left forearms 43R, 43L, and a pair of right and left legs 45R, 45L.

The upper arm 42R protrudes upward from the right end of the upper surface of the module body 41. The upper arm 42R is disposed on the inside of the support portion 66 of the upper portion 64 of the bracket 60R (see FIG. 2) in the vehicle width direction and is fastened to the support portion 66 with two bolts. As a result, two fastening points C7, C8 are provided. The upper arm 42L (see FIG. 1) also has a position and a shape symmetrical right and left to the upper arm 42R, and is fastened to a support portion (not shown) of the upper portion 64 of the bracket 60L by the same mounting structure as the right upper arm 42R.

The forearm 43R protrudes outward from the right side surface of the module body 41. The forearm 43R is disposed on a front surface of the pillar portion 63 of the bracket 60R and is fastened to the pillar portion 63 with a bolt. As a result, the fastening point C9 is provided. The forearm 43L also has a position and a shape symmetrical right and left to the forearm 43R and is fastened to the pillar portion 63 of the bracket 60L with a bolt in the same mounting structure as the right forearm 43R.

The leg 45R is provided on a lower surface of a right end of the front of the module body 41. The leg 45R is disposed on the upper surface of the lower portion 62 of the bracket 60R and is fastened to the lower portion 62 with a bolt. As a result, the fastening point C10 is provided. The leg 45L also has a position and a shape symmetrical right and left to the leg 45R, and is fastened to the lower portion 62 of the bracket 60L with a bolt in the same mounting structure as the right leg 45R.

Next, the effects of the embodiment described above will be described.

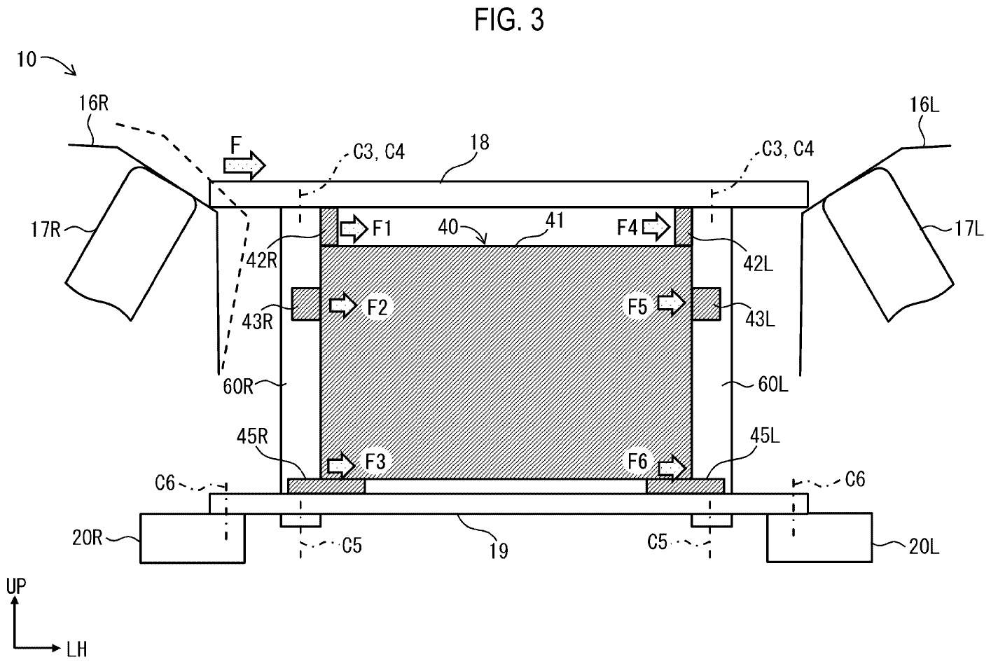

FIG. 3 is a front view schematically showing a front structure of the vehicle 10 according to the embodiment. When the vehicle 10 travels, a load for deforming the suspension towers 16L, 16R is input from the tires (not shown) and the suspensions 17L, 17R. As a result, a load that tries to move the suspension tower bar 18 in the vehicle width direction (right-left direction) occurs.

As illustrated in FIG. 3, when a load diagonally upward from the suspension 17R is input to the suspension tower 16R, the suspension tower 16R tends to fall inward in the vehicle width direction as shown by a broken line in the figure. As a result, a load F directed to the vehicle left direction (right direction in FIG. 3) is generated in the suspension tower bar 18. The load F can be received by the suspension tower 16L on the opposite side, but in a case where the load F is large, the suspension tower bar 18 moves in the vehicle left direction (right direction in FIG. 3), and the body is twisted.

However, according to the embodiment described above, the suspension tower bar 18 is connected to the bottom structure 20L, 20R (vehicle body structure) via the pair of brackets 60L, 60R, the equipment module 40, and the cross member 19. Therefore, the movement of the suspension tower bar 18 toward the vehicle left direction (right direction in FIG. 3) can be suppressed. Therefore, the twisting of the body during traveling of the vehicle can be suppressed. The rigidity of the vehicle body can be increased.

In the example of FIG. 3, the load F of the suspension tower bar 18 is input to the pair of brackets 60L, 60R from the right and left fastening points C3, C4, respectively. A load in a vehicle left direction (right direction in FIG. 3) is generated in the bracket 60R. Due to the load, loads F1, F2, and F3 for pressing the module body 41 in the vehicle left direction (right direction in FIG. 3) are generated on the upper arm 42R, the forearm 43R, and the leg 45R of the equipment module 40, respectively. Due to the loads F1, F2, F3, the loads F4, F5, F6 for pressing the brackets 60L in the vehicle left direction (right direction in FIG. 3) are generated on the upper arm 42L, the forearm 43L, and the leg 45L of the equipment module 40, respectively. The loads F4, F5, F6 are received by the bottom structure 20L through the bracket 60L and the cross member 19. Therefore, the movement of the suspension tower bar 18 in the vehicle left direction (right direction in FIG. 3) can be suppressed.

In particular, in the embodiment described above, the upper arms 42L, 42R of the equipment module 40 are fixed to the upper portions 64 (see FIG. 1) of the brackets 60L, 60R. In the embodiment described above, the legs 45L, 45R of the equipment module 40 are fixed to the lower portions 62 of the brackets 60L, 60R. Therefore, in the example of FIG. 3, a relatively large load F1 is input from the suspension tower bar 18 to the upper arm 42R of the equipment module 40. Then, the load F1 can be transmitted to the lower portion 62 of the bracket 60L at a position relatively close to the bottom structure 20L in the vertical direction. That is, the load F that is applied to the suspension tower bar 18 and that is directed to the vehicle left direction (right direction in FIG. 3) can be efficiently transmitted to the bottom structure 20L through the equipment module 40 and the lower portion 62 of the bracket 60L. Therefore, the movement of the suspension tower bar 18 toward the vehicle left direction (right direction in FIG. 3) can be effectively suppressed.

Although the case where the load F toward the vehicle left direction (right direction in FIG. 3) is generated in the suspension tower bar 18 has been described above, the same effect can be obtained even in a case where the load toward the vehicle right direction (left direction in FIG. 3) is generated in the suspension tower bar 18.

According to the embodiment described above, the load F can be transmitted to the bottom structures 20L, 20R connected to the cross member 19 via the brackets 60L, 60R and the equipment module 40. The load F is a load that is applied to one side of the suspension tower bar 18 in the vehicle width direction (vehicle right-left direction) by the collision load when the vehicle 10 receives the side collision. Therefore, the movement of the suspension tower bar 18 in the vehicle width direction can be suppressed, and the amount of intrusion of the collision object into the vehicle body can be reduced.

What is claimed is:

1. A vehicle front structure comprising:
a suspension tower bar configured to connect upper portions of a pair of right and left suspension towers provided in a front portion of a vehicle to each other;
a cross member that is disposed forward in a vehicle front-rear direction and downward in a vehicle up-down direction of the suspension tower bar and configured to connect right and left vehicle body structures to each other;
a pair of brackets that is bridged between the suspension tower bar and the cross member, the brackets being disposed at an interval in a right-left direction; and
an equipment module including a plurality of pieces of equipment of a refrigeration cycle that is used for adjusting a temperature of vehicle cabin air and a traction battery,
wherein the equipment module is disposed between the brackets and is fixed to each of the brackets.

2. The vehicle front structure according to claim 1, wherein:
each of the brackets includes
an upper portion fixed to the suspension tower bar and extending forward in the vehicle front-rear direction,
a pillar portion extending downward in the vehicle up-down direction from a distal end of the upper portion on a front side of the vehicle, and
a lower portion fixed to the cross member and extending forward in the vehicle front-rear direction from a lower end of the pillar portion; and
the equipment module is fixed to the upper portion and the lower portion of the brackets.

3. The vehicle front structure according to claim 1, wherein the right and left suspension towers and the right and left vehicle body structures to which the cross member is connected are a part of a cast component that is integrally molded.
